(19) United States
(12) Patent Application Publication
(10) Pub. No.: US 2014/0373733 A1
(43) Pub. Date: Dec. 25, 2014

(54) BAKING PAN WITH TAB AND ASSOCIATED TOOL

(71) Applicant: H & H ASIA LTD, Taipei (TW)

(72) Inventor: James Samwell, Worcestershire (GB)

(73) Assignee: H & H ASIA LTD, Taipei (TW)

(21) Appl. No.: 14/312,019

(22) Filed: Jun. 23, 2014

Related U.S. Application Data
(60) Provisional application No. 61/838,651, filed on Jun. 24, 2013.

(51) Int. Cl. A47J 37/01; A47L 13/08; A47J 45/06

(52) U.S. Cl. CPC A47J 37/01; A47J 45/063; A47L 13/08
USPC 99/426; 30/169

(57) ABSTRACT

A baking pan with an improved grasping mechanism comprising a baking surface, a plurality of walls extending upward from the baking surface, a silicone wrapping disposed about outer surfaces of the walls, and a tab extending from the silicone wrapping, the tab extending transversely away from the silicone wrapping to provide a gripping surface. A baking tool for use with a baking pan, the baking tool comprising a nylon portion comprising a lower, flat side; an upper, angled side opposite the lower, flat side; and a nylon tip wherein the upper, angled side meets the lower, flat side. The baking tool further comprises a silicone portion comprising a lower, flat side; an upper, angled side opposite the lower, flat side; and a silicone tip where the upper, angled side meets the lower, flat side.

### CROSS-REFERENCE TO RELATED APPLICATION(S)

This application claims the benefit of U.S. Provisional Application No. 61/838,651, filed on Jun. 24, 2013, which application is hereby incorporated herein by reference in its entirety.

### TECHNICAL FIELD

The present disclosure relates to baking pans, and more particularly, to baking pans having tabs for facilitating handling. Related methods are also described.

### BACKGROUND

Baking pans come in many sizes and shapes and are traditionally heated in an oven for baking various food items. Baking pans often include handles located on either side thereof for providing a surface for a user to grasp while carrying the baking pan. Baking pans are thus typically inserted into an oven with the handles being located at lateral sides of the oven as this is the natural way for a user to insert a baking pan into an oven. Such an arrangement makes it difficult to grasp and move the pan at any location other than the handles. Further, the handles are typically integrated handles manufactured from the same material as the baking pan and often conduct heat when placed into the oven. This presents a dangerous situation when the user has to reach far into the oven to locate and grasp the handles that may be dangerously hot. Accordingly, baking pans having improved grasping mechanisms are desired.

### BRIEF SUMMARY

Disclosed herein is a baking pan comprising a baking surface, a plurality of walls extending upward from the baking surface, a silicone wrapping disposed about outer surfaces of the walls, and a tab extending transversely away from the silicone wrapping to provide a gripping surface.

Further disclosed herein is a baking tool for use with a baking pan, the baking tool comprising a nylon portion comprising a lower, flat side; an upper, angled side opposite the lower, flat side; and a nylon tip wherein the upper, angled side meets the lower, flat side. The baking tool further comprises a silicone portion comprising a lower, flat side; an upper, angled side opposite the lower, flat side; and a silicone tip where the upper, angled side meets the lower, flat side.

### BRIEF DESCRIPTION OF THE DRAWINGS

Embodiments are illustrated by way of example in the accompanying figures, in which like reference numbers indicate similar parts, and in which:

FIG. 1 depicts a baking pan comprising a silicone wrap and tabs in accordance with one embodiment of the present disclosure;

FIG. 2 depicts a baking pan comprising a silicone wrap and tabs in accordance with another embodiment of the present disclosure;

FIG. 3 depicts a baking pan comprising a silicone wrap and tabs in accordance with another embodiment of the present disclosure;

FIG. 4 depicts a baking pan comprising silicone handles in accordance with another embodiment of the present disclosure;

FIG. 5 depicts a muffin baking pan comprising silicone handles and tabs in accordance with another embodiment of the present disclosure; and

FIG. 6 depicts a tool comprising a nylon portion and a silicon portion that may be used with the baking pans depicted in FIGS. 1-5 in accordance with another embodiment of the present disclosure.

### DETAILED DESCRIPTION

The present disclosure relates generally to a baking pan having a tab coupled thereto for handling the baking pan and a tool for use with the baking pan. In some embodiments, the tab is located on a side of the pan as opposed to lateral ends of the pan where the handles are typically located. In other embodiments, handles are replaced with tabs. For example, baking pans that are small enough to insert length-wise into the oven may utilize a tab located at lateral ends of such pans. The tab according to the present disclosure is preferably rounded; however, the tab may take on a variety of configurations that facilitate grasping by the user. Also, the tab may include a projection or area of raised profile to further facilitate gripping by the user.

The tab of the present disclosure may be used with a variety of baking pans. For example, the tab may be used with bread pans, cake pans, sandwich pans, thin trays, and/or deep trays. In some embodiments, only one tab is provided on the baking pan, while in other embodiments, several tabs are provided. The tab according to the present disclosure may be formed of silicone, or partially of silicone.

Having generally described the principles of the present disclosure, attention is now given to exemplary embodiments described with reference to the figures shown herein.

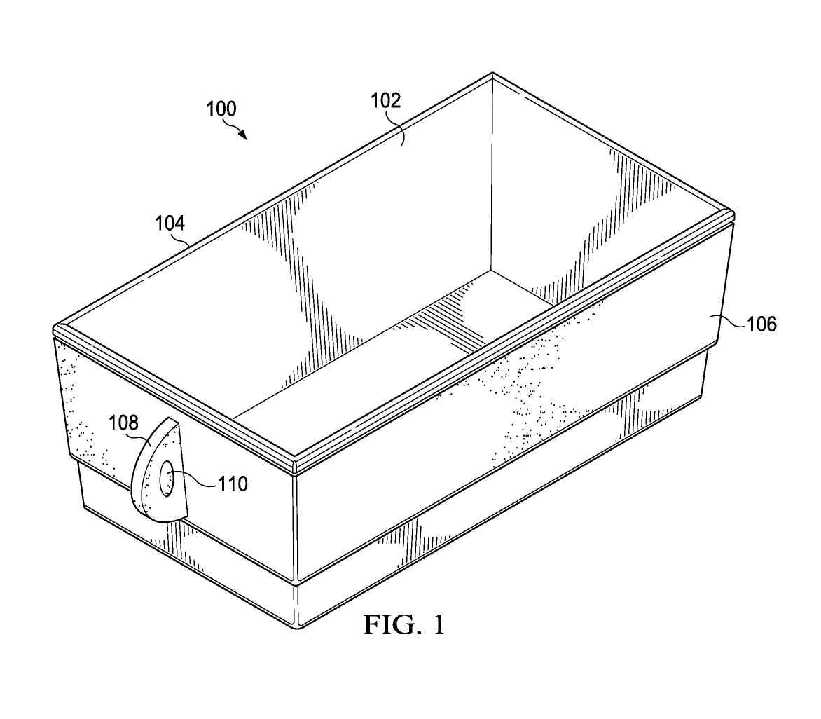

FIG. 1 depicts a baking pan 100 comprising a silicone wrap 106 and tabs 108 (one of which is shown in FIG. 1), in accordance with one embodiment of the present disclosure. The baking pan 100 may be sized and shaped to bake a loaf of bread and may comprise a base and a plurality of walls forming a non-stick baking surface 102 and a rolled edge 104 along upper edges of the walls that is operable to provide additional strength to the baking pan 100.

As depicted in FIG. 1, the tab 108 is coupled to a side of the wrap 106 and may extend transversely away from the silicone wrap 106 in a manner perpendicular to the upper edges of the walls to provide a gripping surface. In other embodiments, the tab 108 may extend transversely away from the silicone wrap in a manner parallel to the upper edges of the walls to provide a gripping surface. The silicone wrap 106 may be integrally connected to the baking pan 100 in such a manner that it is not removable therefrom. However, in other embodiments, the silicone wrap 106 may be modular in nature and thus removable from the baking pan 100. The tab 108 may be semi-circular in shape and thus has a rounded profile. In some embodiments, the tab 108 has a raised portion 110 for providing an additional gripping point beyond the tab 108 itself. That is, a user may be able to grasp the raised portion 110 when removing or moving the baking pan 100. The baking pan 100 may be inserted length-wise into an oven for baking bread. The user may monitor the baking process by grasping the tab 108 and pulling the baking pan 100 towards the user. If more baking is required, the user may engage the tab 108 and push the baking pan 100 back into the oven. If baking is complete, the user may re-position the baking pan 100 and remove the baking pan 100 from the oven.

The tab 108 may be integrally formed with silicone wrap 106 disposed about the baking pan 100. The silicone wrap 106 facilitates handling of the baking pan 100. In some embodiments, indicia may be provided on the silicone wrap 106 to identify the type of baking pan being used. For example, the baking pan 100 may include indicia stating “LOAF” or “BREAD” and indicia may be provided on the silicone wrap 106 to indicate the size of the pan and thus the size of the bread loaf that may be baked in the pan.

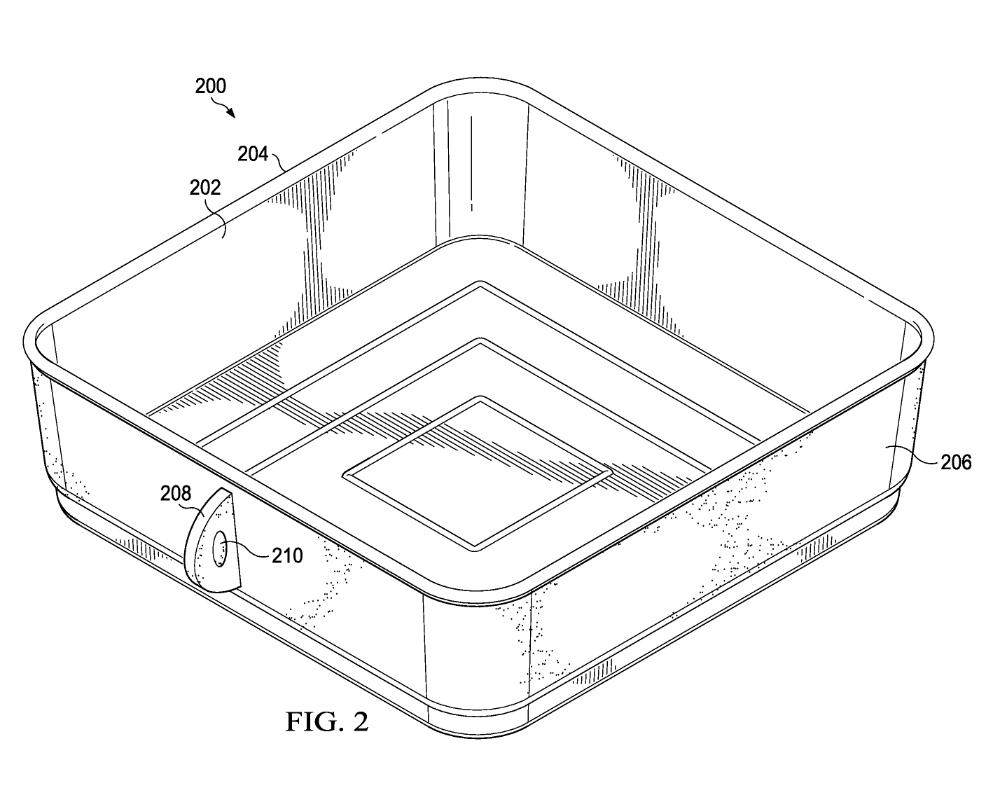

FIG. 2 depicts a baking pan 200 comprising a silicone wrap 206 and tabs 208 (one of which is shown in FIG. 2), in accordance with another embodiment of the present disclosure. The baking pan 200 may be shaped to bake a cake and may comprise a base and a plurality of walls forming a non-stick baking surface 202 and a rolled edge 204 along upper edges of the walls that is operable to provide additional strength to the baking pan 200.

As depicted in FIG. 2, the tab 208 is coupled to a side of the wrap 206 and may extend transversely away from the silicone wrap 206 in a manner perpendicular to the upper edges of the walls to provide a gripping surface. In other embodiments, the tab 208 may extend transversely away from the silicone wrap in a manner parallel to the upper edges of the walls to provide a gripping surface. The silicone wrap 206 may be integrally connected to the baking pan 200 in such a manner that it is not removable therefrom. However, in other embodiments, the silicone wrap 206 may be modular in nature and thus removable from the baking pan 200. The tab 208 may be semi-circular in shape and thus has a rounded profile. In some embodiments, the tab 208 has a raised portion 210 for providing an additional gripping point beyond the tab 208 itself. That is, a user may be able to grasp the raised portion 210 when removing or moving the baking pan 200. The baking pan may 200 be inserted length-wise into an oven for baking a cake. The user may monitor the baking process by grasping the tab 208 and pulling the baking pan 200 towards the user. If more baking is required, the user may engage the tab 208 and push the baking pan 200 back into the oven. If baking is complete, the user may re-position the baking pan 200 and remove the baking pan 200 from the oven.

The tab 208 may be integrally formed with silicone wrap 206 disposed about the baking pan 200. The silicone wrap 206 facilitates handling of the baking pan 200. In some embodiments, indicia may be provided on the silicone wrap 206 to identify the type of baking pan being used. For example, the baking pan 200 may include indicia stating “CAKE” and indicia may be provided on the silicone wrap 206 to indicate the size of the pan and thus the size of the cake that may be baked in the pan.

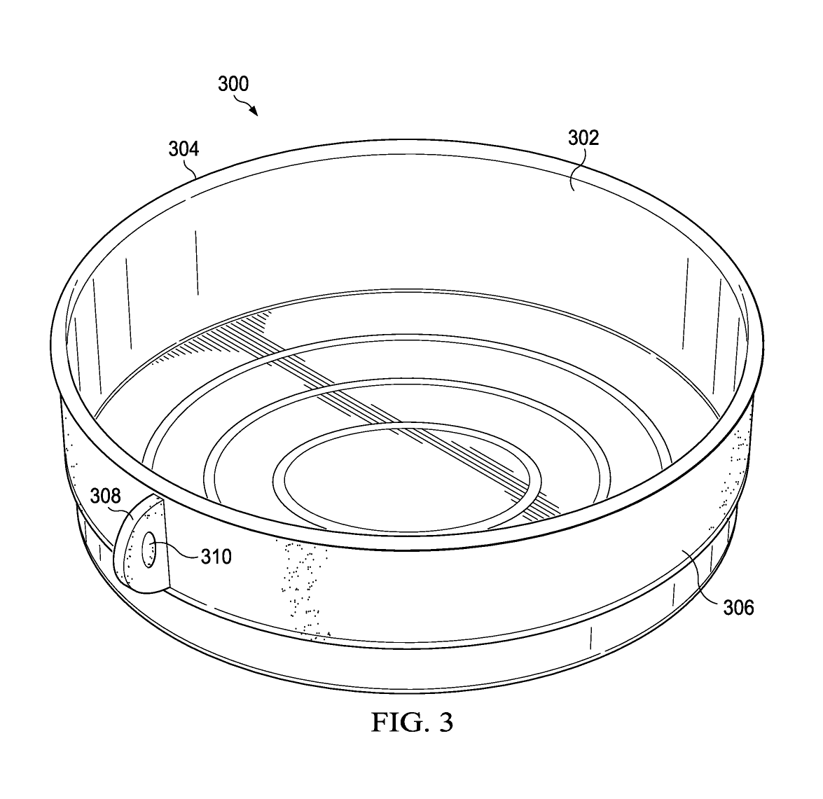

FIG. 3 depicts a baking pan 300 comprising a silicone wrap 306 and tabs 208 (one of which is shown in FIG. 3), in accordance with another embodiment of the present disclosure. The baking pan 300 may be round and sized and shaped to bake a cake or pie and may comprise a base and a continuous wall forming a non-stick baking surface 302 and a rolled edge 304 along upper edges of the wall that is operable to provide additional strength to the baking pan 300.

As depicted in FIG. 3, the tab 308 is coupled to a side of the wrap 306 and may extend transversely away from the silicone wrap 306 in a manner perpendicular to the upper edges of the walls to provide a gripping surface. In other embodiments, the tab 308 may extend transversely away from the silicone wrap in a manner parallel to the upper edges of the walls to provide a gripping surface. The silicone wrap 306 may be integrally connected to the baking pan 300 in such a manner that it is not removable therefrom. However, in other embodiments, the silicone wrap 306 may be modular in nature and thus removable from the baking pan 300. The tab 308 may be semi-circular in shape and thus has a rounded profile. In some embodiments, the tab 308 has a raised portion 310 for providing an additional gripping point beyond the tab 308 itself. That is, a user may be able to grasp the raised portion 310 when removing or moving the baking pan 300. The baking pan may 300 be inserted into an oven for baking a cake or pie. The user may monitor the baking process by grasping the tab 308 and pulling the baking pan 300 towards the user. If more baking is required, the user may engage the tab 308 and push the baking pan 300 back into the oven. If baking is complete, the user may re-position the baking pan 300 and remove the baking pan 300 from the oven.

The tab 308 may be integrally formed with silicone wrap 306 disposed about the baking pan 300. The silicone wrap 306 facilitates handling of the baking pan 300. In some embodiments, indicia may be provided on the silicone wrap 306 to identify the type of baking pan being used. For example, the baking pan 300 may include indicia stating “CAKE” or “PIE” and indicia may be provided on the silicone wrap 306 to indicate the size of the pan and thus the size of the cake or the pie that may be baked in the pan.

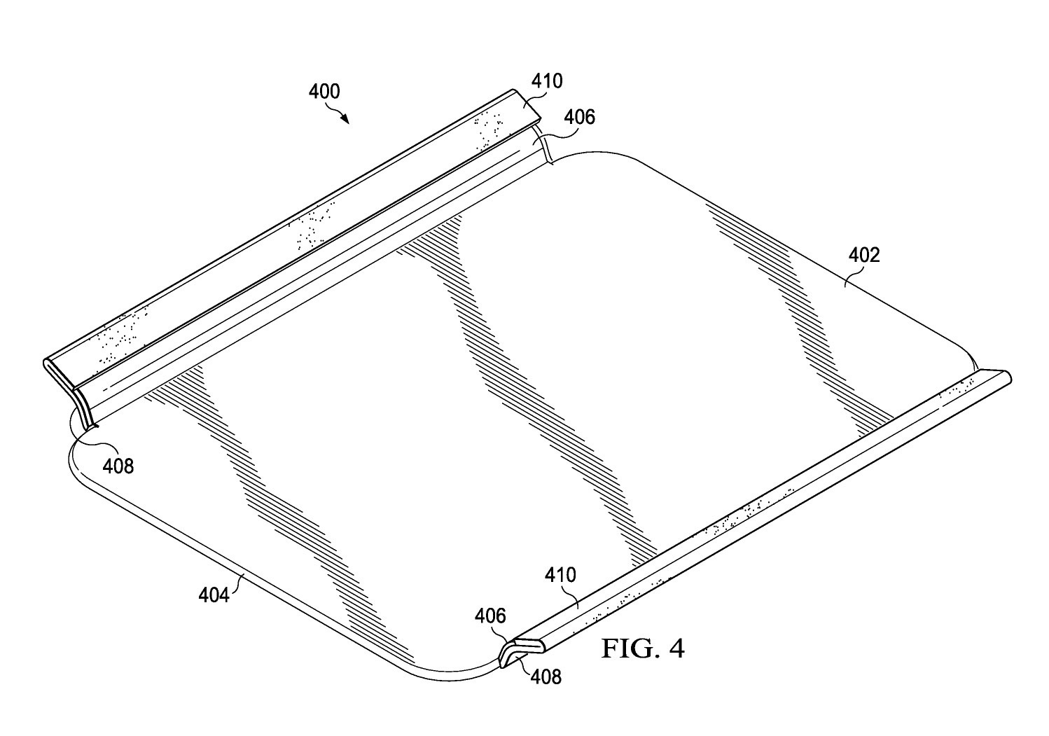

Various other tabs are contemplated as falling within the scope of the present disclosure. For example, with reference to FIG. 4, the tab may extend along the length of a baking tray. FIG. 4 depicts a baking pan 400 comprising silicone handles, in accordance with another embodiment of the present disclosure. The pan 400 may further comprise a baking surface 402 and a rolled edge 404 that is operable to provide additional strength to the baking pan 400. In this embodiment, a pair of tabs 406 are coupled to the relatively shallow baking surface 402 and extend along opposing sides of the pan 400. The tabs 406 are curved away from one another and act as a lip to prevent food from sliding off of the pan 400. The silicone handles are coupled to the tabs 406 and each include a first portion 408 adjacent to the tabs 406 and a second portion 410 that extends beyond the tabs 406. Accordingly, the first portion 408 has the same degree of curvature as the tabs 406. The second portion 410 is thicker than the first portion 408 and continues to curve away from the baking pan 400. Such an arrangement facilitates handling of the baking pan 400 by providing a thicker gripping area of the silicone handles.

In some embodiments, indicia may be provided on the silicone handles to identify the type of baking pan being used. For example, the baking pan 400 may include indicia stating “COOKIES” and indicia may be provided on the silicone handles to indicate the size of the pan.

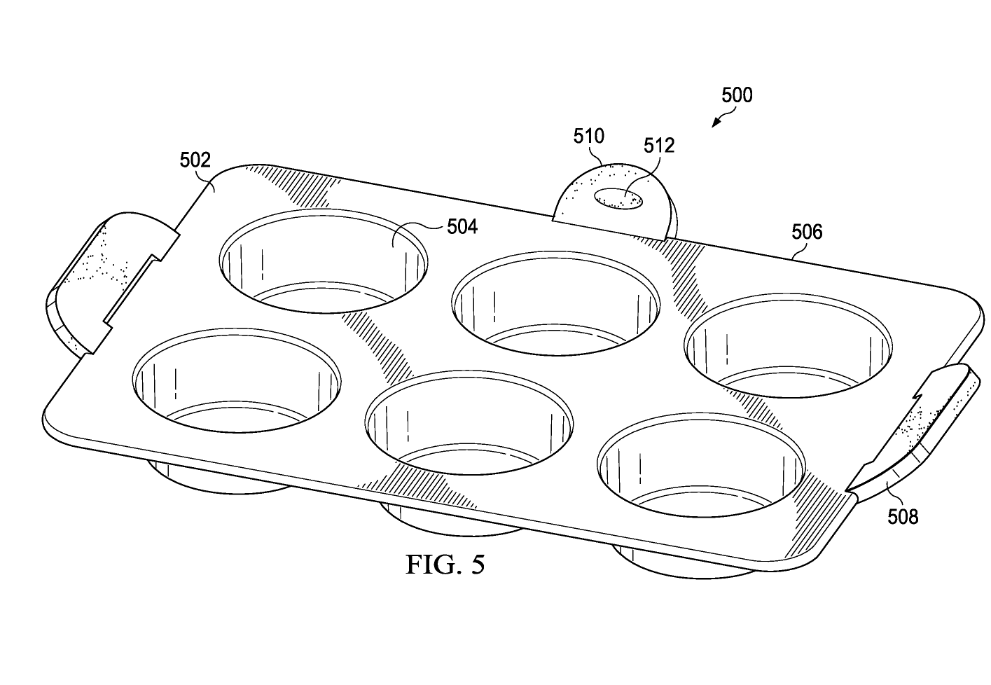

FIG. 5 depicts a muffin baking pan 500 comprising silicone handles 508 and tabs 510, in accordance with another embodiment of the present disclosure. The baking pan 500 may comprise a non-stick baking surface 502 and a rolled edge 506 that is operable to provide additional strength to the baking pan 500. The baking pan 500 may further comprise a plurality of recesses 504 that are operable to receive batter for a plurality of muffins. In an embodiment, the baking pan 500 may have 6 or 12 recesses 504, although any number of recesses 504 may be provided.

As depicted in FIG. 5, the handles 508 may extend from opposing ends of the baking pan 500 and may be used for safe and easy handling of the baking pan 500. The tabs 510 may have a rounded profile, and in some embodiments, the tabs 510 have a raised portion 512 for providing an additional gripping point beyond the tabs 510 themselves. That is, a user may be able to grasp the raised portion 512 when removing or moving the baking pan 500. The baking pan may 500 be inserted length-wise into an oven for baking muffins. The user may monitor the baking process by grasping the handles 508 or the tabs 510 and pulling the baking pan 500 towards the user. If more baking is required, the user may engage the handles 508 or the tabs 510 and push the baking pan 500 back into the oven. If baking is complete, the user may re-position the baking pan 500 and remove the baking pan 500 from the oven.

In some embodiments, indicia may be provided to identify the type of baking pan being used. For example, the baking pan 500 may include indicia stating “MUFFINS” and indicia may be provided to indicate the size of the pan.

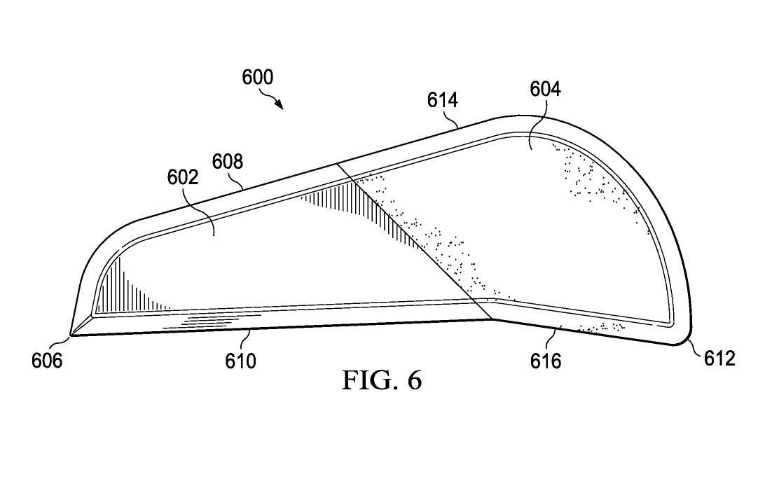

Various tools may be used with the baking pans of the present disclosure. For example, with reference to FIG. 6, a scraper tool for use with the baking pans disclosed herein includes a nylon portion and a silicone portion. FIG. 6 depicts a tool 600 comprising a nylon portion 602 and a silicon portion 604 that may be used with the baking pans depicted in FIGS. 1-5, in accordance with another embodiment of the present disclosure.

The tool 600 increases in size from the nylon portion 602 to the silicone portion 604. The nylon portion 602 includes a lower, flat side 610 opposed to an upper, angled side 608. A third side of the nylon portion is defined at the interface of the nylon and silicone portions. The upper side 608 decreases sharply towards the distal end of the nylon portion 602 to meet the lower side 610 at a tip 606. Such an arrangement facilitates use of the tool 600 to cut against and loosen the sides of a cake freshly baked in a baking pan. That is, a user may grip the silicone portion 604 and use the nylon portion 602 to free the cake from the pan.

The silicone portion 604 is generally larger in size than the nylon portion 602 and includes a lower side 616 that angles outward from the lower side 610 of the nylon portion 602. An upper side 614 of the silicone portion 604 continues to extend along the same angle defined by the upper side 608 of the nylon portion 602 adjacent to the silicone portion 604. The upper side 614 decreases sharply towards the distal end of the silicone portion 604 to meet the lower side 616 at a tip 612. Although the silicone portion 604 may be used as a handle for using the nylon portion 602 as a tool, it may also be used as a tool itself. For example, the nylon portion 602 may be gripped by the user and the silicone portion 604 may be used as a bowl scraper.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language under this heading to describe the so-called technical field. Further, a description of technology in the “Background” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A baking pan, comprising:
a baking surface;
a plurality of walls extending upward from the baking surface;
a silicone wrapping disposed about outer surfaces of the walls; and
a tab extending from the silicone wrapping, the tab extending transversely away from the silicone wrapping to provide a gripping surface.

2. The baking pan of claim 1, further comprising a rolled edge along upper edges of the walls, wherein the rolled edge is operable to provide additional strength to the baking pan.

3. The baking pan of claim 1, wherein the tab is semi-circular in shape.

4. The baking pan of claim 1, wherein the tab further comprises a raised portion operable to provide an additional gripping point.

5. The baking pan of claim 1, wherein the baking surface is a non-stick surface.

6. The baking pan of claim 1, wherein the tab is integrally formed with the silicone wrapping.

7. The baking pan of claim 1, wherein the silicone wrapping further comprises indicia to identify the size and type of baking pan.

8. The baking pan of claim 1, wherein the baking pan is rectangular.

9. The baking pan of claim 1, wherein the baking pan is square.

10. The baking pan of claim 1, wherein the baking pan is round.

11. The baking pan of claim 1, wherein the baking plan is a baking tray.

12. The baking pan of claim 1, wherein the baking pan is a muffin tray.

13. The baking pan of claim 1, further comprising a plurality of tabs extending from the silicone wrapping, the tabs extending transversely away from the silicone wrapping to provide gripping surfaces.

14. The baking pan of claim 1, further comprising one or more silicone handles operable to provide one or more additional gripping points.

15. A baking tool for use with a baking pan, the baking tool comprising:
a nylon portion comprising:
a lower, flat side;
an upper, angled side opposite the lower, flat side; and
a nylon tip where the upper, angled side meets the lower, flat side; and
a silicone portion adjacent to the nylon portion, comprising:
a lower, flat side;
an upper, angled side opposite the lower, flat side; and
a silicone tip where the upper, angled side meets the lower, flat side.

16. The baking tool of claim 15, wherein the upper, angled side of the nylon portion decreases sharply towards a distal end of the nylon portion to meet the lower, flat side at the nylon tip.

17. The baking tool of claim 15, wherein the upper, angled side of the silicone portion decreases sharply towards a distal end of the silicone portion to meet the lower, flat side at the silicone tip.

18. The baking tool of claim 15, wherein the nylon tip is operable to cut against and loosen sides of a cake baked in the baking pan.

19. The baking tool of claim 15, wherein the silicon portion is operable to be used as a handle.

20. The baking tool of claim 15, wherein the silicone portion is operable to be used as a scraper.
